(19) United States
(12) Patent Application Publication
(10) Pub. No.: US 2005/0155208 A1
(43) Pub. Date: Jul. 21, 2005

(54) Card and paper money retainer

(76) Inventor: Raymond L. Schneider III, Green Bay, WI (US)

Correspondence Address: Donald J. Ersler, 725 Garvens Avenue, Brookfield, WI, 53005, US

(21) Appl. No.: 10/757,887

(22) Filed: Jan. 15, 2004

(51) Int. Cl. B23P 11/02

(52) U.S. Cl. 29/450

(57) ABSTRACT

A card and paper money retainer includes a flat sheet. The flat sheet is preferably, substantially the same size as a credit card. The flat sheet is preferably fabricated from a flexible plastic, but other materials may also be used. The flat sheet could also be a fully functional card. Two opposing clips are formed on each end of the flat sheet by forming a substantially U-shaped slot through each end of the flat sheet. Paper money and/or credit cards are inserted between the opposing clips. In a second embodiment of the card and paper money retainer, two lengthwise slots are formed through substantially a middle of the flat sheet. The two lengthwise slots create a retention strap. Paper money and/or credit cards are inserted between the retention strap and the flat sheet.

### BACKGROUND OF THE INVENTION

1. Field of the Invention

The present invention relates generally to money clips and more specifically to a card and paper money retainer, which may be stored in a wallet or a money clip, when not in use.

2. Discussion of the Prior Art

The prior art provides numerous money clips and card holders. Money clips and card holders are typically utilized, when a person does not desire to carry a bulky wallet around. U.S. Pat. No. 5,077,869 to Haase discloses a money and credit card carrier. The Haase patent invention includes a new and improved credit card/money clip device provided by a base member having first and second generally opposed major surfaces and a clip for holding currency or credit cards. U.S. Pat. No. 5,358,019 to Sumner, III discloses a pocket card holder with money clip. The Sumner, III invention includes a thin flat device having a money clip on one side together with two parallel channels on the reverse side to accommodate credit cards and the like. However, the Sumner device cannot be reasonably stored in a wallet, because of its thickness.

Accordingly, there is a clearly felt need in the art for a card and paper money retainer, which may be stored in a wallet or money clip, when not in use; can retain credit cards and paper money; and may serve as a fully functional card.

### SUMMARY OF THE INVENTION

The present invention provides a card and money paper retainer, which may be reasonably stored in a wallet or a money clip, when not in use. The card and paper money retainer includes a flat sheet. The flat sheet is preferably, substantially the same size as a credit card. The flat sheet could also be a fully functional credit card, identification card or any other type of suitable card. The flat sheet is preferably fabricated from a flexible plastic, but other materials may also be used. Two opposing clips are created in the flat sheet by forming a substantially U-shaped slot through substantially each end of the flat sheet. Paper money and/or credit cards are inserted between the opposing clips by flexing the ends of the flat sheet, such that a space is created between the clips and the flat sheet.

In a second embodiment of the card and paper money retainer, two lengthwise slots are formed through substantially a middle of the flat sheet. The two lengthwise slots create a retention strap. Paper money and/or credit cards are inserted between the retention strap and the flat sheet by flexing the ends of the flat sheet, such that a space is created between the retention strap and the flat sheet.

Accordingly, it is an object of the present invention to provide a card and paper money retainer, which may be stored in a wallet or a money clip, when not in use.

It is a further object of the present invention to provide a card and paper money retainer, which serve as a fully functional card.

Finally, it is another object of the present invention to provide a card and paper money retainer, which can retain credit cards and paper money.

These and additional objects, advantages, features and benefits of the present invention will become apparent from the following specification.

### BRIEF DESCRIPTION OF THE DRAWINGS

FIG. 1 is a perspective view of a card and paper money retainer in accordance with the present invention.

FIG. 2 is a perspective view of a card and paper money retainer with paper money and a card retained thereby in accordance with the present invention.

FIG. 3 is a cross-sectional view of a card and paper money retainer with paper money and a card retained thereby in accordance with the present invention.

FIG. 4 is a perspective view of a second embodiment of a card and paper money retainer in accordance with the present invention.

FIG. 5 is a perspective view of a second embodiment of a card and paper money retainer with paper money and a card retained thereby in accordance with the present invention.

FIG. 6 is a cross-sectional view of a second embodiment of a card and paper money retainer with paper money and a card retained thereby in accordance with the present invention.

### DETAILED DESCRIPTION OF THE PREFERRED EMBODIMENTS

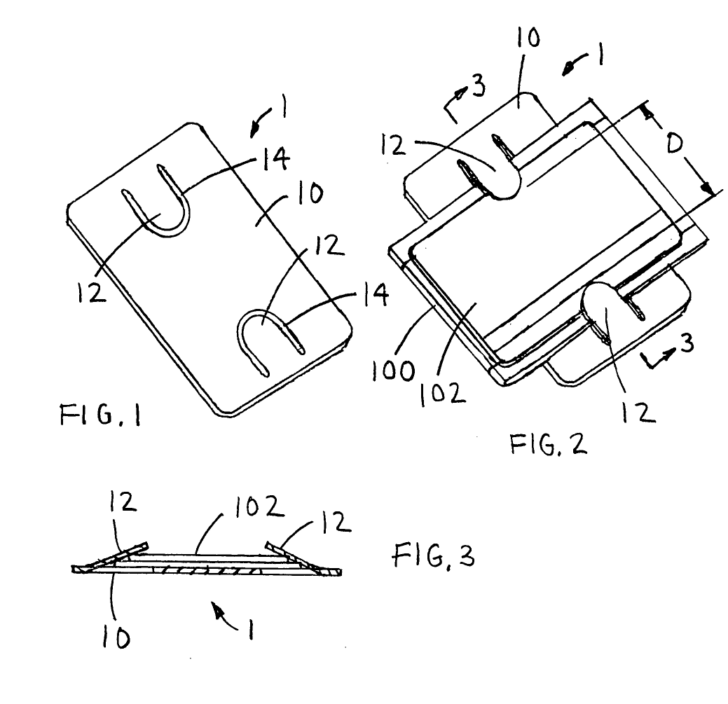

With reference now to the drawings, and particularly to FIG. 1, there is shown a perspective view of a card and paper money retainer 1. With reference to FIGS. 2-3, the card and paper money retainer 1 includes a flat sheet 10. The flat sheet 10 is preferably, substantially the same size and shape as a credit card. The flat sheet 10 could also be a fully functional credit card, identification card or any other type of suitable card. However, the flat sheet 10 may be any other appropriate shape and/or size. The flat sheet 10 is preferably fabricated from a flexible plastic, but other materials may also be used. Two opposing clips 12 are created in the flat sheet 10 by forming a substantially U-shaped slot 14 through substantially each end of the flat sheet 10. The distance “D” between the ends of the two opposing clips is sufficient to overlap the width of a credit card. Paper money 100 and/or credit cards 102 are inserted between the two opposing clips 12 by flexing the ends of the flat sheet 10, such that a space is created between the two opposing clips 12 and the flat sheet 10.

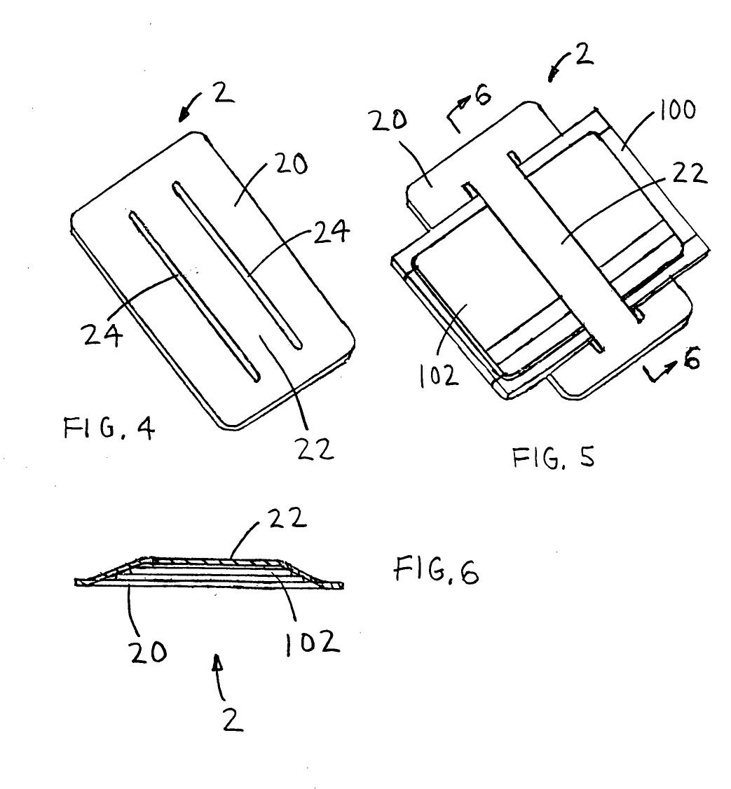

With reference to FIGS. 4-6, a second embodiment of the card and paper money retainer 2 includes a flat sheet 20. The flat sheet 20 is preferably, substantially the same size and shape as a credit card. The flat sheet 20 could also be a fully functional credit card, identification card, bank card or any other type of suitable card. However, the flat sheet 20 may be any other appropriate shape and/or size. The flat sheet 20 is preferably fabricated from a flexible plastic, but other materials may also be used. A retention strap 22 is created by forming two lengthwise slots 24 through substantially a middle of the flat sheet 20. Paper money 100 and/or credit cards 102 are inserted between the retention strap 22 and the flat sheet 20 by flexing the ends of the flat sheet 20, such that a space is created between the retention strap 22 and the flat sheet 20.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method of retaining paper money or at least one credit card, comprising the steps of:
providing a flat sheet;
forming two opposing substantially U-shaped slots through said flat sheet at substantially each end thereof to create two opposing clips; and
flexing said flat sheet such that the paper money or the at least one credit card may be inserted between said two opposing clips and said flat sheet.

2. The method of retaining paper money or at least one credit card of claim 1, further comprising the step of:
providing a distance between said two opposing clips that is sufficient to retain a width of a credit card.

3. The method of retaining paper money or at least one credit card of claim 1, further comprising the step of:
storing said flat sheet in a wallet or a money clip when not in use.

4. The method of retaining paper money or at least one credit card of claim 1, further comprising the step of:
fabricating said flat sheet from a flexible material.

5. The method of retaining paper money or at least one credit card of claim 1, further comprising the step of:
flexing said flat sheet to insert the paper money and the at least one credit card between said two opposing clips and said flat sheet.

6. The method of retaining paper money or at least one credit card of claim 1, further comprising the step of:
forming said flat sheet substantially the same size and shape as a credit card.

7. The method of retaining paper money or at least one credit card of claim 1, further comprising the step of:
forming said flat sheet from a fully functional card.

8. A method of retaining paper money or at least one credit card, comprising the steps of:
providing a flat sheet;
forming two lengthwise slots through substantially a middle of said flat sheet to create a retention strap; and
flexing said flat sheet such that the paper money or the at least one credit card may be inserted between said retention strap and said flat sheet.

9. The method of retaining paper money or at least one credit card of claim 8, further comprising the step of:
storing said flat sheet in a wallet or a money clip when not in use.

10. The method of retaining paper money or at least one credit card of claim 8, further comprising the step of:
fabricating said flat sheet from a flexible material.

11. The method of retaining paper money or at least one credit card of claim 8, further comprising the step of:
flexing said flat sheet to insert the paper money and the at least one credit card between said retention strap and said flat sheet.

12. The method of retaining paper money or at least one credit card of claim 8, further comprising the step of:
forming said flat sheet substantially the same size and shape as a credit card.

13. The method of retaining paper money or at least one credit card of claim 8, further comprising the step of:
forming said flat sheet from a fully functional card.

14. A method of retaining paper money or at least one credit card, comprising the steps of:
providing a fully functional card;
forming two lengthwise slots through substantially a middle of said flat sheet to create a retention strap; and
flexing said flat sheet such that the paper money or the at least one credit card may be inserted between said retention strap and said flat sheet.

15. The method of retaining paper money or at least one credit card of claim 14, further comprising the step of:
storing said flat sheet in a wallet or a money clip when not in use.

16. The method of retaining paper money or at least one credit card of claim 14, further comprising the step of:
fabricating said flat sheet from a flexible material.

17. The method of retaining paper money or at least one credit card of claim 14, further comprising the step of:
flexing said flat sheet to insert the paper money and the at least one credit card between said retention strap and said flat sheet.
